(19) United States
(12) Patent Application Publication
(10) Pub. No.: US 2006/0158401 A1
(43) Pub. Date: Jul. 20, 2006

(54) Integrated display unit

(76) Inventor: Christianus Hermanus Leopold Weijtens, Valkenswaard (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,282

(22) PCT Filed: Jun. 21, 2004
(86) PCT No.: PCT/IB04/50942

§ 371 Date: Dec. 22, 2005

(30) Foreign Application Priority Data
Jun. 26, 2003 (EP) 03101906.0

(51) Int. Cl. G09G 3/32

(52) U.S. Cl. 345/82

(57) ABSTRACT

An integrated display unit described with a display having a plurality of display elements (Dx) which are joined together into a plurality of groups, and with various circuit arrangements for controlling the display. The display is in particular a pixel-based display such as, for example, a (P or O) LED matrix with groups in the form of display elements arranged in rows and columns. The operating principle of the circuit arrangements is that of a shift register, wherein the usually N×M external contacts for the scanning and data lines can be reduced to a number of eight or ten such contacts. An essential advantage of the circuit arrangements is that they can be integrated together with the matrix display into display unit on a single circuit board.

The invention relates to an integrated display unit with a display having a plurality of display elements which are combined into a plurality of groups, in particular with a pixel-based display such as, for example, a (P or O) LED matrix with groups in the form of display elements arranged in rows and columns, as well as with a circuit arrangement for controlling the display.

A pixel-based display is composed, for example, of a matrix-shaped arrangement of individual display elements such as, for example, LEDs such as PLEDs (polymeric LEDs) or OLEDs (organic LEDs), which are arranged in a plurality of groups in the form of N rows and M columns. In the simplest case, each row and each column has its own electrical contacts for controlling or electrically supplying the display elements, such that the display has a total number of N+M external electrical connections. The number of connections, and thus also the expenditure for the associated driver circuits, may be very high in particular in the case of displays with a large number of display elements, which is regarded as disadvantageous.

Various suggestions have already been made for reducing the number of external connections of such a display by certain measures.

EP 0 809 228, for example, discloses a driver arrangement with decoders or shift registers by means of which the rows and/or columns of an LED matrix display are controlled or selected. A disadvantage of this driver device, however, is that the number of decoder elements or bus lines is still comparatively high.

It is accordingly an object of the invention to provide an integrated display unit of the kind mentioned in the opening paragraph in which the number of external connection terminals required is reduced even more strongly.

A further object of the invention is to provide an integrated display unit of the kind mentioned in the opening paragraph in which the display and the circuit arrangement for controlling the display can be accommodated on a common chip in a space-saving manner.

This object is achieved in accordance with claim 1 by means of an integrated display unit with:

a display with a plurality of display elements (Dx) which are combined into a plurality of groups,

a circuit arrangement for controlling the display with a plurality of switches (Sw1, Sw2, . . . ) which can be closed with a first clock signal and opened with a second clock signal, and with a plurality of inverters (In1, In2, . . . ), wherein the switches and inverters are connected in series in mutual alternation, such that

each group of display elements (Dx) is connected to an output of an inverter (In1, In2, . . . ) each, and with

at least one clock bus line (Φ1, Φ2) via which the first and the second clock signal are supplied in alternation to the first, third, fifth, etc. switch (Sw1, Sw3, Sw5, . . . ) of the series arrangement, and the second and the first clock signal are supplied in alternation to the second, fourth, sixth, etc. switch (Sw2, Sw4, Sw6, . . . ), so that after the application of a third clock signal to the input of the series arrangement, consecutively at a time at least one group of display elements (Dx) is activated.

A particular advantage of this solution is that the clock bus lines only have a comparatively low capacity for reasons to be explained further below, and can in addition be arranged at the edge of the display. This has the result firstly that the individual display elements can be positioned at a smaller mutual distance and secondly that the clock bus lines can have a comparatively great width, so that a correspondingly low resistance and a comparatively short RC time of these lines are achieved.

A further advantage of the solution is that the display unit can be constructed both for interlaced and for non-interlaced operation of the groups of display elements.

It is to be noted here that shift register arrangements are indeed known from U.S. Pat. No. 4,723,168 and U.S. Pat. No. 4,903,284, which are provided for controlling a CCD chip for image registration, but not for an LED matrix. This prior art, therefore, is not regarded as relevant to the present product type.

The dependent claims relate to advantageous further embodiments of the invention.

The embodiment of claim 2 renders it possible to realize a comparatively high density of the display elements (i.e. a smaller distance between these elements) on the one and. On the other hand, the clock bus lines may be given a comparatively great width, so that their resistance is correspondingly low.

The embodiment of claim 3 relates to an arrangement of the display which is preferably provided as part of the integrated display unit.

Claim 4 relates to an advantageous realization of the circuit arrangement.

Claims 5 and 6 relate to a display unit with a circuit arrangement for the non-interlaced control of the groups of display elements.

Claims 7 to 9 by contrast relate to an interlaced control of the groups of display elements. These embodiments also have the advantage that not only the scanning lines, but also the data lines of the display can be controlled.

Further details, features, and advantages of the invention will become apparent from the ensuing description of preferred embodiments, which is given with reference to the drawing in which:

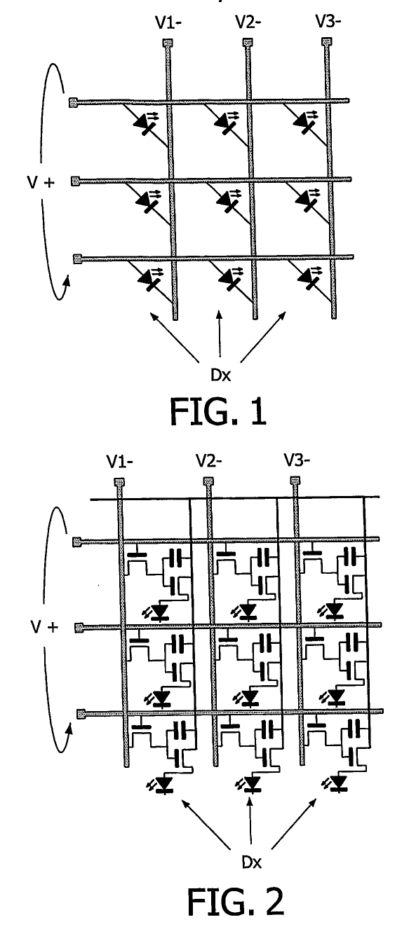

FIG. 1 is a circuit diagram of a passive LED matrix;

FIG. 2 is a circuit diagram of an active LED matrix;

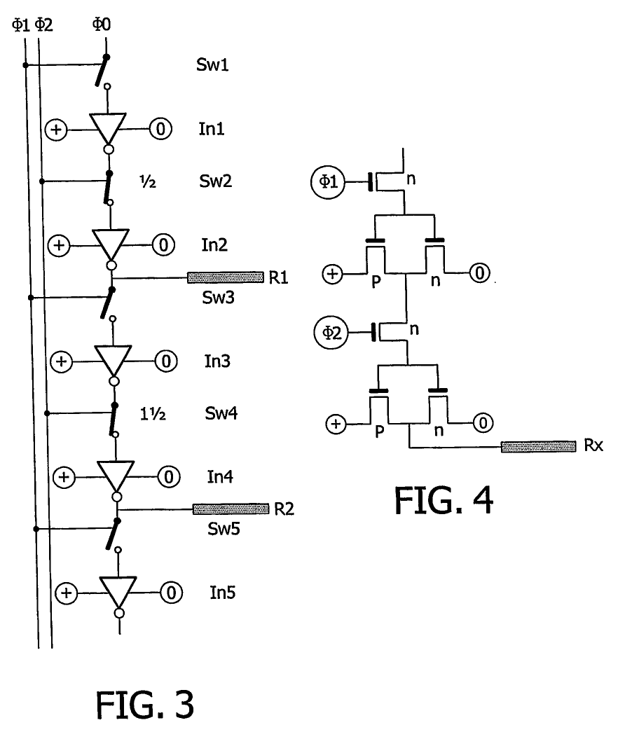

FIG. 3 shows part of a first circuit arrangement for controlling the rows of an LED matrix;

FIG. 4 shows part of the first circuit arrangement in detail;

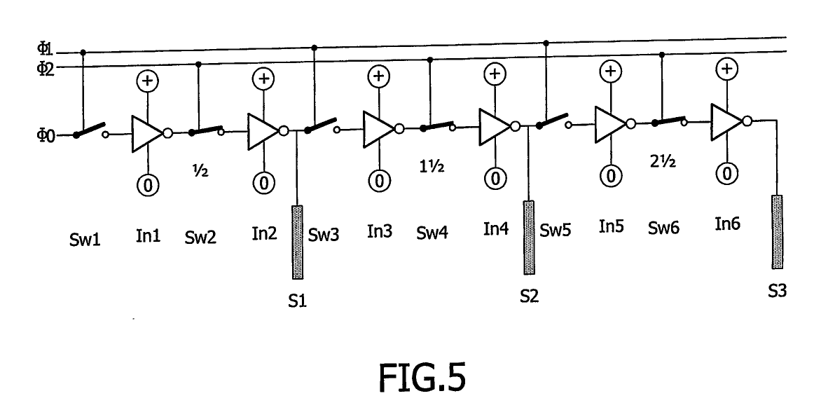

FIG. 5 shows the circuit arrangement of FIG. 3 for controlling the columns of an LED matrix;

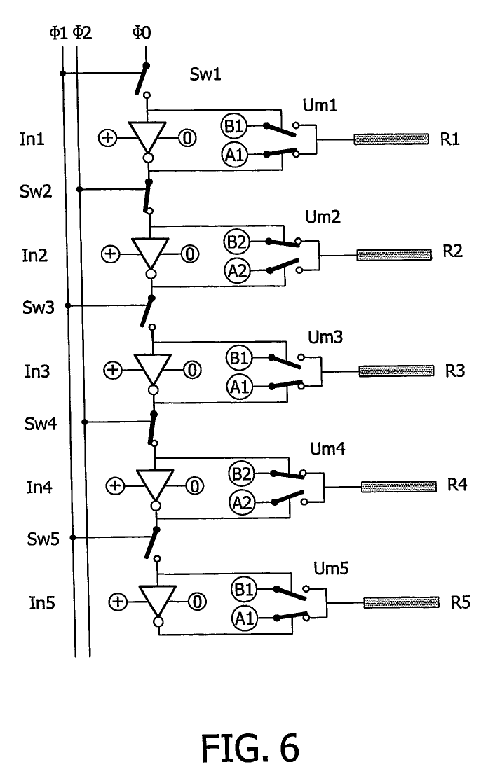

FIG. 6 shows part of a second circuit arrangement for controlling the rows of an LED matrix;

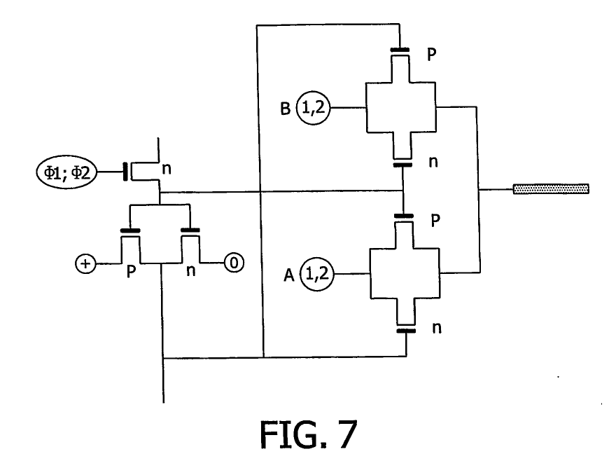

FIG. 7 shows part of the second circuit arrangement in detail;

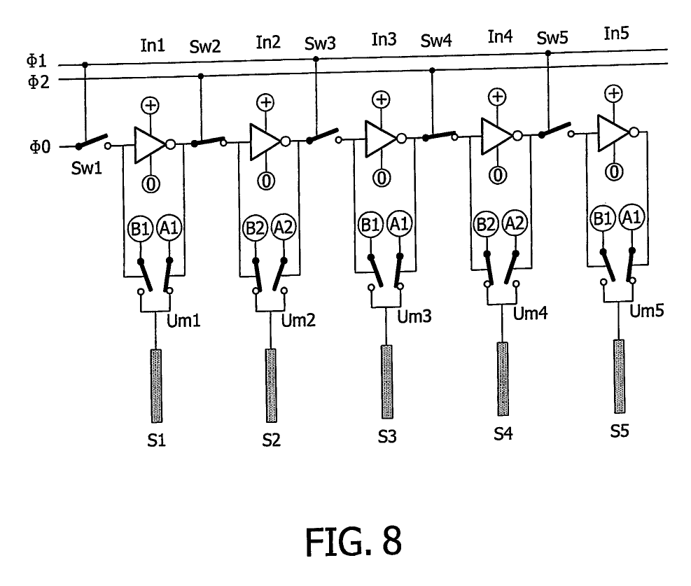

FIG. 8 shows the circuit arrangement of FIG. 6 for controlling the columns of an LED matrix; and

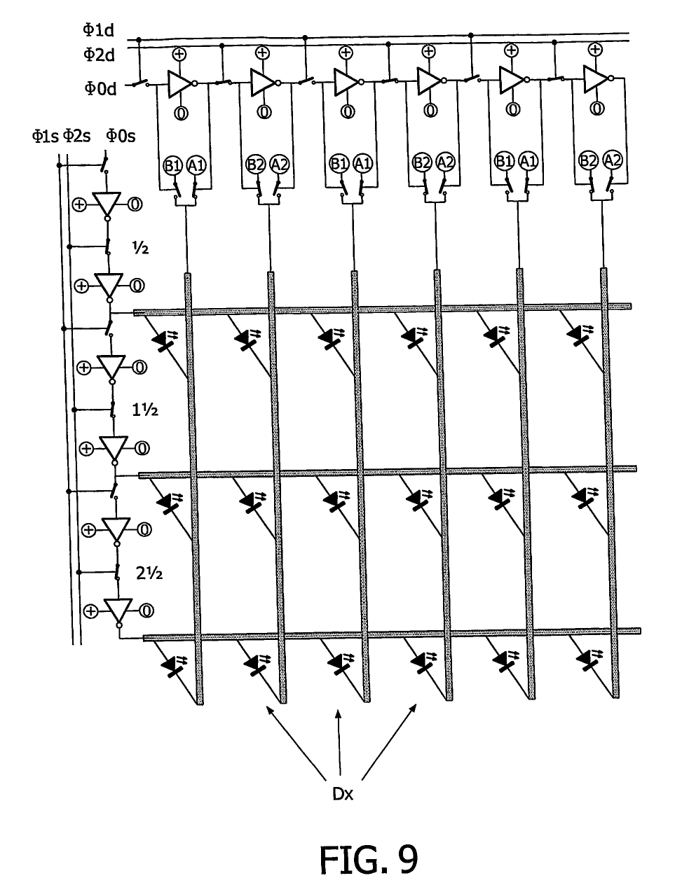

FIG. 9 shows a display unit with a first and a second circuit arrangement and with a passive LED matrix.

FIG. 1 diagrammatically shows a known passive (P or O) LED matrix display, and FIG. 2 shows a known active display. The displays comprise display elements Dx which are arranged in groups in the form of three horizontal rows (N=3) and three vertical columns (M=3), so that a total of nine display elements Dx (pixels) in the form of (P or O) LED elements can be controlled. The rows are sequentially addressed during operation of the display, i.e. they are consecutively connected to the positive pole V+ of a supply voltage one after the other and thus activated (scanning lines), while the signals (data lines) containing the image information to be displayed are applied to the columns V1−, V2−, V3−. These signals are applied in a known manner in dependence on the instantaneously activated row at any time. The number of external connections (in general bond connections) required for controlling such a display thus is N+M. These are six connection terminals in the case discussed here.

FIG. 3 shows a first circuit arrangement according to the invention for controlling the scanning lines, i.e. in the case of FIG. 3 the horizontal rows R1, R2, . . . of an active or passive matrix display. The display elements may be active and/or passive LEDs, PLEDs (polymeric LEDs) and/or OLEDs (organic LEDs).

The circuit arrangement is composed of a series arrangement of a first switch Sw1 and a first inverter In1, a second switch Sw2 and a second inverter In2, etc., such that a first row R1 is connected to the output of the second inverter In2 and a second row R2 is connected to the output of the fourth inverter In4, etc., of the matrix display. The number of switches Sw and inverters In is such that each row R of the matrix display can be connected to the circuit arrangement in the manner described.

The first, third, fifth switches Sw1, Sw3, Sw5, . . . etc. are switched via a first clock bus line Φ1, and the second, fourth switches Sw2, Sw4, . . . etc. are switched via a second clock bus line Φ2.

The switches Sw1, Sw2, . . . can be closed by a first clock signal and opened by a second clock signal, which clock signals are supplied to the switches via the relevant clock bus lines.

The switches Sw1, Sw2, . . . etc. are switched alternately with the first and with the second clock signal such that either the switches Sw1, Sw3, Sw5, . . . etc. connected to the first clock bus line Φ1 are open and the switches Sw2, Sw4, . . . etc. connected to the second clock bus line Φ2 are closed, or the switches Sw1, Sw3, Sw5, . . . etc. connected to the first clock bus line Φ1 are closed and the switches Sw2, Sw4, . . . etc. connected to the second clock bus line Φ2 are open.

A start pulse supplied through a third clock bus line Φ0 is applied to the input of the series arrangement (i.e. of the first switch Sw1).

The inverters In1, In2, . . . in their turn are connected to a positive (+) and a negative (−) terminal of a supply voltage (DC bus).

A switching unit is accordingly required for controlling each row Rx of the display, which unit is composed, for example in the case of the first row R1, of the series arrangement of the first switch Sw1, the first inverter In1, the second switch Sw2, and the second inverter In2.

FIG. 4 shows such a switching unit in detail. The two switches Sw1, Sw2 are each formed by an n-transistor, and the two inverters In1, In2 are each formed by a parallel arrangement of a p-transistor and an n-transistor.

The use of this circuit arrangement for controlling the N rows of a matrix display, therefore, requires three connections for the three clock bus lines Φ0, Φ1, Φ2 and two connections for the positive and negative DC bus (+, −), independently of the number N of rows R1, R2, . . . , i.e. a total of five connections or bus lines. The circuitry expenditure amounts to 4×N n-transistors and 2×N p-transistors (cf. FIG. 4).

The clock bus lines Φ0, Φ1, Φ2 each have a comparatively small capacity because each of them serves merely to address a number of N transistors at any time. Furthermore, the first and the second clock bus line Φ1, Φ2 may in particular be arranged at the edge of the display and need not extend through the field of the (P)LED elements of the display, so that the clock bus lines Φ1, Φ2 may have a greater width. This leads to a correspondingly lower resistance and a comparatively low RC time of the clock bus lines.

The circuit arrangement together with the display can be arranged and integrated on a single carrier or chip for these reasons. The actual display may then be fitted substantially more densely with display elements because the clock bus lines are arranged at the edge thereof. This is a major advantage, in particular in the case of an active (P)LED matrix.

The clock bus lines Φ1, Φ2 arranged at the edge of the display are preferably made of aluminum.

The first circuit arrangement performs the function of a shift register. After the start pulse has been applied to the third clock bus line Φ0, each row Rx in turn is individually connected to the positive pole (+) of the supply voltage applied to the relevant inverter In1 In2, . . . by means of the first and second clock signals (+, 0) on the first and second clock bus lines Φ1, Φ2 (whereby the switches Sw1, Sw3, . . . ; Sw2, Sw4, . . . connected thereto are opened and closed, as applicable).

The rows Rx may obviously also be connected to the negative pole (−) of the supply voltage applied to the relevant inverter in dependence on the nature of the (P or O) LED elements, for example if the rows Rx are connected to the respective outputs of the first, third, etc. inverters In1, In2, . . . . Furthermore, the rows Rx may also be activated by a combination of a DC voltage and a pulsed signal.

The N (scanning) rows Rx of the display are thus sequentially addressed in a non-interlaced manner. Table 1 shows by way of example a clock diagram for a (P or O) LED matrix display with N=3 rows.

TABLE 1

| Pulse | Φ0 | Φ1 | Φ2 | ½ | 1 | 1½ | 2 | 2½ | 3 |
|---|---|---|---|---|---|---|---|---|---|
| 0 | 0 | − | − | + | 0 | + | 0 | + | 0 |
| 1 | + | + | 0 | 0 | 0 | + | 0 | + | 0 |
| 2 | + | 0 | + | 0 | + | + | 0 | + | 0 |
| 3 | 0 | + | 0 | + | + | 0 | 0 | + | 0 |
| 4 | 0 | 0 | + | + | 0 | 0 | + | + | 0 |
| 5 | 0 | + | 0 | + | 0 | + | + | 0 | 0 |
| 6 | 0 | 0 | + | + | 0 | + | 0 | 0 | + |
| 7 | 0 | + | 0 | + | 0 | + | 0 | + | + |
| 8 | 0 | 0 | + | + | 0 | + | 0 | + | 0 |

The columns headed “½”, “1½”, “2½” here indicate the levels at the outputs of the inverters In1, In3, In5, . . . present between the respective connections for the rows R1, R2, R3. The bold + signs in the columns “1”, “2”, and “3” show the respective addressed rows R1, R2, . . . in which the (P or O) LED elements are activated in accordance with the signals applied to the columns of the matrix display and containing the image information.

It is apparent from Table 1 that all N=3 rows have been addressed after eight clock pulses (i.e. 2N+2) after the start pulse was applied to the third clock bus line Φ0.

The light emission of the LED elements of the relevant row then starts with a 0 level each time at the first clock bus line Φ1 and ends with a 0 level at the second clock bus line Φ2.

If a matrix display with LED elements is used which are to be addressed not with a positive (+) level as in the case described above but with a 0-level, this may be achieved in that the start pulse applied to the third clock bus line Φ0 is a positive level at the pulse moments 0 and 3 to 8 in Table 1 and a 0-level at the pulse moments 1 and 2.

Alternatively, given the same clock pulse and level diagram as in Table 1, the rows R1, R2, . . . of the matrix display to be addressed may also be connected to the outputs of the inverters In1, In3, in5, . . . of FIG. 3 denoted “½”, “1½”, “2½” etc., as was explained above.

FIG. 5 shows the first circuit arrangement in an embodiment for controlling the (scanning) columns S1, S2, S3 of a matrix display, where these represent the scanning lines (whereas the data lines are to be connected to the rows R1, R2, R3, . . . ).

This arrangement is substantially identical to the arrangement shown in FIG. 3 as regards circuitry, so that reference can be made to the explanations relating to FIGS. 3 and 4 and Table 1 as regards its elements and functions.

In contrast to FIG. 3, however, the first, second, and third columns S1, S2, S3, . . . of the matrix display are now connected to the outputs of the second, fourth, sixth, etc. inverters In2, In4, In6, . . . .

FIG. 6 shows a second circuit arrangement according to the invention for controlling the rows R1, R2, R3, . . . of an active or passive (P or O) LED matrix display.

The circuit arrangement is again formed by a series circuit of a first switch Sw1, a first inverter In1, a second switch Sw2, a second inverter In2, etc., as shown in FIG. 3.

The first, third, fifth, . . . switches Sw1, Sw3, Sw5, . . . etc. are again switched via a first clock bus line D1, whereas the second, fourth, . . . switches Sw2, Sw4, . . . etc. are switched via a second clock bus line Φ2.

The switches are again opened and closed by means of a first and a second clock signal, respectively, such that in alternation either the switches Sw1, Sw3, Sw5, . . . etc. connected to the first clock bus line Φ1 are open and the switches Sw2, Sw4, . . . etc. connected to the second clock bus line Φ2 are closed, or the switches Sw1, Sw3, Sw5, . . . etc. connected to the first clock bus line Φ1 are closed and the switches Sw2, Sw4, . . . etc. connected to the second clock bus line Φ2 are open.

A start pulse supplied via a third clock bus line Φ0 is again applied to the input of the series arrangement (i.e. of the first switch Sw1).

The inverters In1, In2, . . . in their turn are connected to a positive (+) and a negative (−) terminal of a supply voltage DC bus), as in FIG. 3.

In contrast to the first circuit arrangement, a converter Um1, Um2, . . . is associated with each inverter In1, In2, . . . in this second circuit arrangement. In more detail, the first, third, fifth, etc. row R1, R3, R5, . . . of the display is connected to a fourth or a fifth clock bus line A1, B1 via a respective first, third, fifth converter Um1, Um3, Um5, . . . , while the second, fourth, sixth, etc. row R2, R4, R6, . . . is connected to a sixth or seventh clock bus line A2, B2 via a respective second, fourth, sixth converter Um2, Um4, etc. . . .

The converters Um1, Um2, . . . as shown in FIG. 6 each have two contacts which are switched by the signal applied to the input or the output of the respective associated inverter In1, In2, . . . , such that at any time one of the contacts is open and the other one is closed.

This modification of the first circuit arrangement renders it possible to control the connected rows R1, R2, R3, . . . of the matrix display in the interlaced mode.

FIG. 6 shows the simplest case of the interlaced control (line skipping method) in accordance with the “abab” schedule with two half images. To select a first half image, a 1-level is to be applied to the fifth clock bus line B1 and a 0-level to the sixth clock bus line A2, whereas the selection of a second half image is made by applying a 0-level to the fifth clock bus line B1 and a 1-level to the sixth clock bus line A2.

The fourth and the seventh clock bus line A1, B2 are fixedly connected to the 0-level, so that both may have the same bond connection. This bond connection may also be used as a 0-lead for the circuit arrangement, if so desired.

A switching unit is thus required for controlling each row Rx which is composed, for example in the case of the first row R1, of the series arrangement of the first switch Sw1 and the first inverter In1 plus the first converter Um1.

FIG. 7 shows such a switching unit in detail. The switch Sw is formed by an n-transistor and the inverter In by a parallel arrangement of a p-transistor and an n-transistor, while the converter Um is realized by means of two on/off switches each comprising a p- and an n-transistor.

The use of this second circuit arrangement for controlling the N rows of a matrix display accordingly requires three connection terminals for the first to third clock bus lines Φ0, Φ1, Φ2 and two connection terminals for the fifth and the sixth clock bus line B1, A2, independently of the number N of the rows Rx. Furthermore, two connections are to be provided for the positive and negative DC bus (+, −) for the inverter. This leads to a total of 7 bus lines. The circuitry expenditure amounts to 4×N n-transistors and 3×N p-transistors (cf. FIG. 7).

The first and the second clock bus lines Φ1, Φ2 again each have a comparatively low capacity because they each address no more than N transistors. Furthermore, the clock bus lines Φ0, Φ1, Φ2 do not extend directly through the field of the (P)LED elements, but may be arranged at the edge of the display, so that they may again have a comparatively great width, a low resistance, and a comparatively short RC time. For these reasons, this second circuit arrangement may again be integrated with the display on a joint chip or carrier so as to form a display unit, wherein the actual display again can be provided with display elements considerably more densely, because the clock bus lines are preferably arranged at the outer edge thereof.

The operational function of the second circuit arrangement is again that of a shift register. After the start pulse has been applied to the third clock bus line Φ0, the positive pole (+) of the supply voltage applied to the relevant inverter ln1, In2, . . . is consecutively provided to each of the rows Rx by means of the first and the second clock signal (+, 0) on the first and the second clock bus line Φ1, Φ2, in accordance with the explanation given with respect to the first circuit arrangement.

The rows Rx may alternatively be connected to the negative pole (−) of the supply voltage applied to the relevant inverter in dependence on the nature of the (P or O) LED elements, as was explained above, or may be supplied with a combination of a DC voltage and a pulsed signal.

The selection of the two half images here takes place by means of the voltage level applied to the fifth and the sixth clock bus line B1, A2, as was explained above. The application of a 1-level to the fifth clock bus line B1 and of a 0-level to the sixth clock bus line A2 controls the (P)LED elements of a first half image (the rows R1, R3, R5, etc. in succession), whereas the (P)LED elements of the second half image (the rows R2, R4, R6, etc. in succession) are activated by means of a 0-level applied to the fifth clock bus line B1 and a 1-level to the sixth clock bus line A2.

If a matrix display with (P or O) LED elements is used which are not to be controlled with a positive level, as in the case discussed above, but with a 0-level, this may be realized in a simple manner in that the fourth and seventh clock bus lines A1, B2 are set not for the 0-level, but for the 1-level. Since the rows are addressed with a 0-level in this case, the LED elements of the second half image (the rows R2, R4, R6, etc. in succession) are activated by a 1-level at the fifth clock bus line B1 and a 0-level at the sixth clock bus line A2. However, when a 0-level is applied to the fifth clock bus line B1 and a 1-level to the sixth clock bus line A2, the first half image is displayed (the rows R1, R3, R5, etc. in succession).

The fourth and seventh clock bus lines A1, B2 are preferably not fixedly connected to a 0-level terminal of the circuit board, but are constructed with a switch-over possibility, so as to be able to operate both kinds of (P or O)LEDs with the same circuit layout. Furthermore, adjustments may then also be made for differences between the threshold values of the transistors of the circuit arrangement and the LEDs (passive matrix, organic substances) or the pixel transistors (active matrix).

The N rows Rx of the display are accordingly addressed sequentially and in the interlaced mode with the second embodiment of the circuit arrangement. Table 2 shows as an example of this a pulse diagram for a (P or O) LED matrix display with N=6 rows.

TABLE 2

| Pulse | Φ0 | Φ1 | Φ2 | 1 | 2 | 3 | 4 | 5 | 6 |
|---|---|---|---|---|---|---|---|---|---|
| 0 | 0 | − | − | + A1 | 0 B2 | + A1 | 0 B2 | + A1 | 0 B2 |
| 1 | + | + | 0 | 0 B1 | 0 B2 | + A1 | 0 B2 | + A1 | 0 B2 |
| 2 | + | 0 | + | 0 B1 | + A2 | + A1 | 0 B2 | + A1 | 0 B2 |
| 3 | 0 | + | 0 | + A1 | + A2 | 0 B1 | 0 B2 | + A1 | 0 B2 |
| 4 | 0 | 0 | + | + A1 | 0 B2 | 0 B1 | + A2 | + A1 | 0 B2 |
| 5 | 0 | + | 0 | + A1 | 0 B2 | + A1 | + A2 | 0 B1 | 0 B2 |
| 6 | 0 | 0 | + | + A1 | 0 B2 | + A1 | 0 B2 | 0 B1 | + A2 |
| 7 | 0 | + | 0 | + A1 | 0 B2 | + A1 | 0 B2 | + A1 | + A2 |
| 8 | 0 | 0 | + | + A1 | 0 B2 | + A1 | 0 B2 | + A1 | 0 B2 |

The Table entries contain, in addition to the 1- and 0-levels at the outputs of the inverters In1, In2, . . . of the associated rows R1, R2, . . . indicated with the symbols + and 0, also the connected fourth to seventh clock bus lines A1, B1, A2, B2 and thus the respective switch positions of the converters Um1, Um2, Um3, . . . for the rows R1, R2, R3, (and thus the voltages applied to the rows under the given conditions).

It is apparent from Table 2 that a half image, i.e. the rows R1, R3, and R5 or the rows R2, R4, and R6 (those printed in bold characters) of a matrix display having N=6 lines have been addressed after eight clock pulses subsequent to the application of the start pulse to the third clock bus line Φ0.

It is also clear from Table 2 that a non-interlaced control of the rows of the matrix display is obtained in the case in which a 1-level is applied both to the fifth and to the sixth clock bus line B1, A2. In this case, however, two rows are addressed simultaneously, so that in general an undesirable loss of image resolution will occur.

FIG. 8 shows the second circuit arrangement in a version for the control of the columns S1, S2, S3 of a matrix display.

This arrangement is substantially identical to the circuit arrangement shown in FIG. 6 as regards circuitry, so that reference is made to the explanations relating to FIGS. 6 and 7 and Table 2 as regards its elements and functions. The difference with FIG. 6 is that the columns S1, S2, S3, . . . of the matrix display are connected to the converters Um1, Um2, Um3, . . . .

It is possible with the second circuit arrangement to realize also other interlacing schemes, for example a “abcdabcd” interlaced operation, if further clock bus lines A and B are provided and are connected, for example, to the converters Um3 and Um4.

The second circuit arrangement, unlike the first circuit arrangement, is capable of controlling not only the scanning lines (i.e. scanning rows or scanning columns), but alternatively also the data lines of a display. In such a case, the fifth and sixth clock bus lines B1, A2 are switched over not with the half-image frequency between the 0- and 1-level, but with the LED frequency between the 0-level and the LED data level. Switching takes place between the 1-level and the LED data level in the case of LED elements with inverted addressing (with the diodes having an inverted polarity with respect to that shown in FIG. 9).

FIG. 9 finally shows a display unit with N=3 rows and M=6 columns, wherein the (passive) LED matrix display accordingly comprises the 18 LED elements (display elements Dx) as shown. The rows of the display are controlled by a circuit arrangement in accordance with the first embodiment, whereas the columns are controlled with a circuit arrangement in accordance with the second embodiment so as to supply them with the data signals.

The rows are consecutively activated (scanning rows) here via the three clock bus lines Φ0s, Φ1s, Φ2s of the first circuit arrangement as described above, while the signals containing the image information to be displayed (data columns) are applied to the second circuit arrangement via the five clock bus lines Φ0d, Φ1d, Φ2d, B1, A2 as explained above.

A positive or negative supply voltage is applied to the inverters again via two DC buses (+, −). Ten bus lines are thus necessary in total independently of the number of rows and columns of the display.

The circuitry expenditure for the control of the matrix display of the display unit amounts to 12 (=4×N)+24 (=4×M) n-transistors and 6 (=2×N)+18 (−3×M) p-transistors.

Finally, it is alternatively possible to control the scanning rows of the matrix display also with the second circuit arrangement.

The matrix display would then be controlled via a total of ten clock bus lines and two DC buses, i.e. a total of 12 bus lines, independently of the number of rows and columns of the display.

In this case, the display shown in FIG. 9 would have N=3 rows and M=6 columns, resulting in a circuitry requirement for the control of the matrix display of in total 12 (=4×N)+24 (=4×M) n-transistors and 9 (=3×N)+18 (=3×M) p-transistors.

It is true for both circuit arrangements as well as for their combinations for the control of the rows and/or columns of a display that active matrix elements in accordance with FIG. 2 may be used instead of the passive matrix elements shown.

1. An integrated display unit with:
a display with a plurality of display elements (Dx) which are combined into a plurality of groups,
a circuit arrangement for controlling the display with a plurality of switches (Sw1, Sw2, . . . ) which can be closed with a first clock signal and opened with a second clock signal, and with a plurality of inverters (In1, In2, . . . ), wherein the switches and inverters are connected in series in mutual alternation, such that
each group of display elements (Dx) is connected to an output of an inverter (In1, In2, . . . ) each, and with
at least one clock bus line (Φ1, Φ2) via which the first and the second clock signal are supplied in alternation to the first, third, fifth, etc. switch (Sw1, Sw3, Sw5, . . . ) of the series arrangement, and the second and the first clock signal are supplied in alternation to the second, fourth, sixth, etc. switch (Sw2, Sw4, Sw6, . . . ), so that after the application of a third clock signal to the input of the series arrangement, consecutively at a time at least one group of display elements (Dx) is activated.

2. An integrated display unit as claimed in claim 1, with a carrier on which the display elements (Dx) are arranged in the form of a display field, wherein the at least one clock bus line (Φ1, Φ2) extends along the edge of the display field.

3. An integrated display unit as claimed in claim 1, wherein the groups of display elements (Dx) are each formed by a row or a column of a matrix display.

4. An integrated display unit as claimed in claim 1, wherein the switches (Sw1, Sw2, . . . ) are each formed by an n-transistor, and the inverters (In1, In2, . . . ) are each formed by a parallel arrangement of a p-transistor and an n-transistor.

5. An integrated display unit as claimed in claim 1, wherein the groups of display elements (Dx) in the non-interlaced control of said groups are connected to respective outputs of the second, fourth, sixth, etc. inverter (In2, In4, In6, . . . ) of the series arrangement.

6. An integrated display unit as claimed in claim 5, wherein the groups of display elements (Dx) are the sampled rows or sampled columns of a matrix display.

7. An integrated display unit as claimed in claim 1, wherein the groups of display elements (Dx) for the interlaced control of said groups can each be connected via a converter (Um1, Um2, . . . ) to a fifth or sixth clock bus line (B1, A2) for the half-image switch-over, and the converters (Um1, Um2, . . . ) can each be switched over by means of a signal applied to the input and/or the output of the associated inverter (In1, In2, . . . ).

8. An integrated display unit as claimed in claim 7, wherein the converters (Um1, Um2, . . . ) are formed by two on/off switches each comprising a p- and an n-transistor.

9. An integrated display unit as claimed in claim 7, wherein the groups of display elements (Dx) are the sampled rows and/or the sampled scanning columns and/or the data rows and/or the data columns of a matrix display.
